(19) United States
(12) Patent Application Publication
(10) Pub. No.: US 2016/0369957 A1
(43) Pub. Date: Dec. 22, 2016

(54) Lighting System

(71) Applicant: Dallas Griffin, Vail, AZ (US)

(72) Inventor: Dallas Griffin, Vail, AZ (US)

(21) Appl. No.: 14/744,849

(22) Filed: Jun. 19, 2015

(51) Int. Cl. F21L 4/04; F21V 21/08; F21V 21/16; F21V 23/04; F21V 21/14; A45C 15/06; F21L 4/06

(52) U.S. Cl. CPC F21L 4/045; A45C 15/06; F21V 21/08; F21L 4/06; F21V 23/0414; F21V 21/145; F21V 21/16; F21Y 2101/02

(57) ABSTRACT

A lighting system for illuminating a selected area within a bag includes a bag that has an outer wall. The outer wall has an inner surface and a lighting unit is coupled to the bag. The lighting unit is positioned on the inner surface such that the lighting unit selectively illuminates an interior of the bag. The lighting unit is positionable at a selectable angle with respect to the bag thereby facilitating the lighting unit to illuminate a selected area within the bag.

### BACKGROUND OF THE DISCLOSURE

Field of the Disclosure

The disclosure relates to lighting devices and more particularly pertains to a new lighting device for illuminating a selected area within a bag.

### SUMMARY OF THE DISCLOSURE

An embodiment of the disclosure meets the needs presented above by generally comprising a bag that has an outer wall. the outer wall has an inner surface and a lighting unit is coupled to the bag. The lighting unit is positioned on the inner surface such that the lighting unit selectively illuminates an interior of the bag. The lighting unit is positionable at a selectable angle with respect to the bag thereby facilitating the lighting unit to illuminate a selected area within the bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a lighting system according to an embodiment of the disclosure.

FIG. 2 is a back view of an embodiment of the disclosure.

FIG. 3 is a front view of an embodiment of the disclosure.

FIG. 4 is a right side view of an embodiment of the disclosure.

FIG. 5 is a perspective in-use view of an embodiment of the disclosure.

### DESCRIPTION OF THE PREFERRED EMBODIMENT

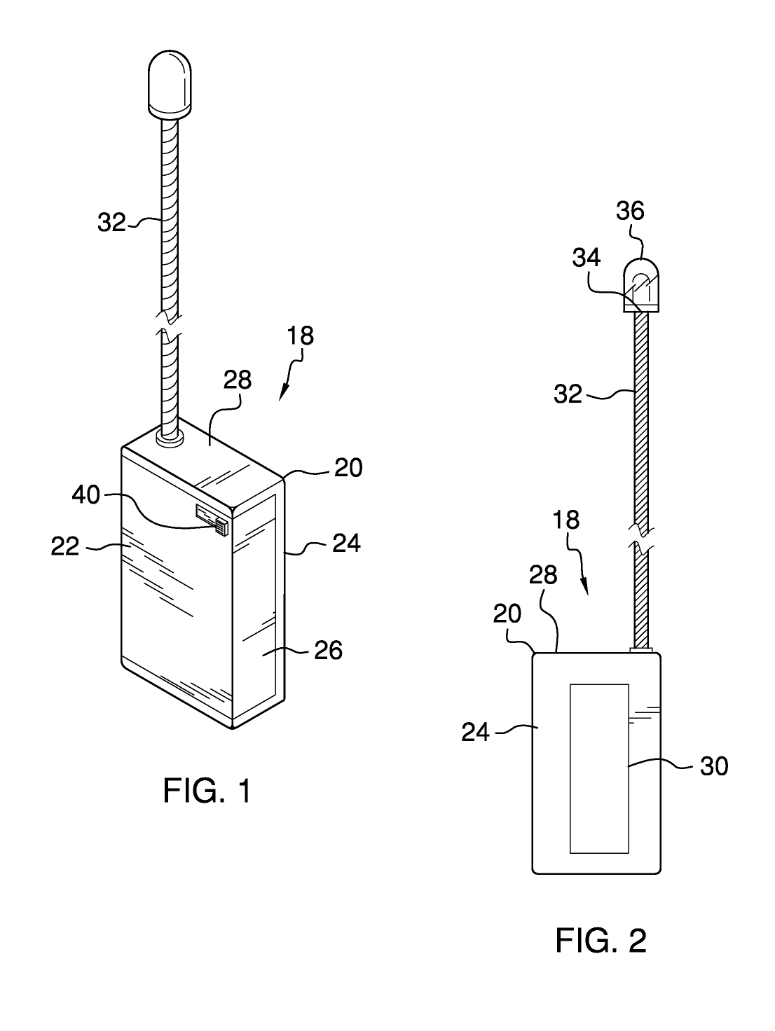

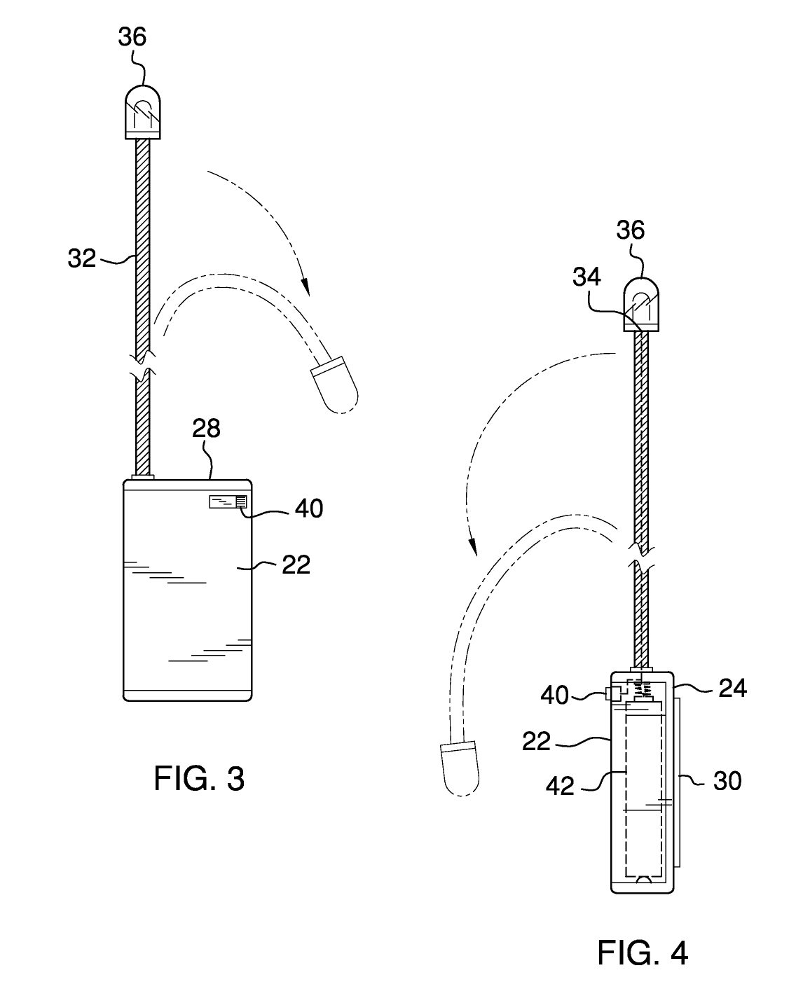

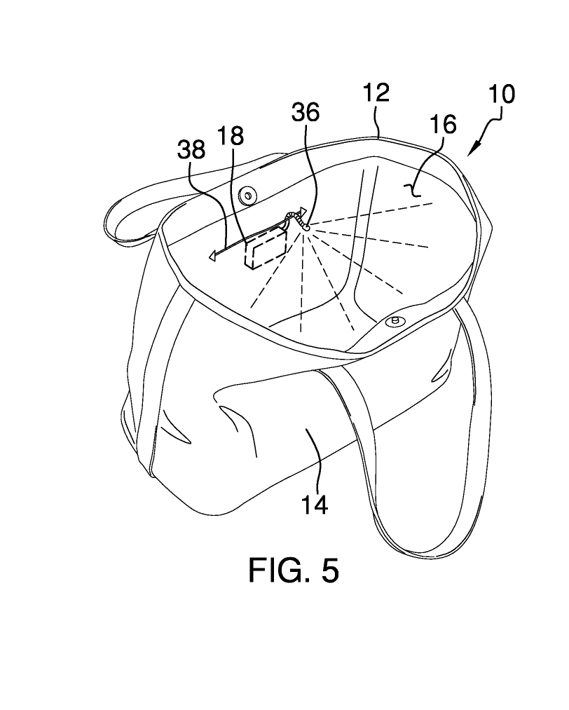

With reference now to the drawings, and in particular to FIGS. 1 through 5 thereof, a new lighting device embodying the principles and concepts of an embodiment of the disclosure and generally designated by the reference numeral 10 will be described.

As best illustrated in FIGS. 1 through 5, the lighting system 10 generally comprises a bag 12 that has an outer wall 14. The outer wall 14 has an inner surface 16 and the bag 12 may comprise a purse or the like. A lighting unit 18 is coupled to the bag 12 and the lighting unit 18 is positioned on the inner surface 16. Thus, the lighting unit 18 selectively illuminates an interior of the bag 12. The lighting unit 18 is positionable at a selectable angle with respect to the bag 12 thereby facilitating the lighting unit 18 to illuminate a selected area within the bag 12.

The lighting unit 18 comprises a housing 20 that has a front wall 22, a back wall 24 and a peripheral wall 26 extending between the front wall 22 and the back wall 24. The peripheral wall 26 has a top side 28 and an attachment 30 is coupled to the back wall 24. The attachment 30 engages the inner surface 16 of the bag 12 such that the housing 20 is retained on the inner surface 16. The attachment 30 may comprise a hook and loop fastener, a clip or other conventional means of removably coupling the housing 20 to the bag 12.

A stem 32 is provided and the stem 32 is coupled to and extends upwardly from the top side 28. The stem 32 has a distal end 34 with respect to the top side 28 and the stem 32 is comprised of a flexible material. Thus, the distal end 34 may be directed toward the selected area within the bag 12. A light emitter 36 is coupled to the distal end 34. The light emitter 36 emits light such that the light emitter 36 selectively illuminates the selected area. The light emitter 36 may comprise an LED or the like. The inner surface 16 of the bag 12 may have a pocket 38 therein. The housing 20 may be positioned within the pocket 38 such that the stem 32 extends outwardly from the pocket 38.

A switch 40 is provided and the switch 40 is coupled to the front wall 22. The switch 40 is electrically coupled to the light emitter 36 such that the switch 40 turns the light emitter 36 on and off. The switch 40 is slidable between an on position and an off position. A power supply 42 is positioned within the housing 20 and the power supply 42 is electrically coupled to the switch 40. The power supply 42 comprises at least one battery 44.

In use, the housing 20 is removably attached to the inner surface 16 of the bag 12. The stem 32 is manipulated to direct the light emitter 36 toward the selected area. The switch 40 is manipulated into the on position such that the light emitter 36 illuminates the selected area thereby facilitating the selected area to be visually inspected. The switch 40 is manipulated into the off position when the selected area no longer needs to be illuminated.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A lighting system comprising:
a bag having an outer wall, said outer wall having an inner surface; and
a lighting unit being coupled to said bag, said lighting unit being positioned on said inner surface such that said lighting unit selectively illuminates an interior of said bag, said lighting unit being positionable at a selectable angle with respect to said bag thereby facilitating said lighting unit to illuminate a selected area within said bag.

2. The system according to claim 1, wherein said lighting unit comprises a housing having a front wall, a back wall and a peripheral wall extending between said front wall and said back wall, said peripheral wall having a top side.

3. The system according to claim 2, further comprising an attachment being coupled to said back wall, said attachment engaging said inner surface of said bag such that said housing is retained on said inner surface.

4. The system according to claim 1, wherein said lighting unit comprises:
a housing having a top side; and
a stem being coupled to and extending upwardly from said top side, said stem having a distal end with respect to said top side, said stem being comprised of a flexible material thereby facilitating said distal end to be directed toward said selected area within said bag.

5. The system according to claim 4, further comprising a light emitter being coupled to said distal end, said light emitter emitting light such that said light emitter selectively illuminates said selected area.

6. The system according to claim 5, further comprising:
said housing having a front wall; and
a switch being coupled to said front wall, said switch being electrically coupled to said light emitter such that said switch turns said light emitter on and off.

7. The system according to claim 1, further comprising a power supply being positioned within said housing, said power supply being electrically coupled to said switch, said power supply comprising at least one battery.

8. A lighting system comprising:
a bag having an outer wall, said outer wall having an inner surface; and
a lighting unit being coupled to said bag, said lighting unit being positioned on said inner surface such that said lighting unit selectively illuminates an interior of said bag, said lighting unit being positionable at a selectable angle with respect to said bag thereby facilitating said lighting unit to illuminate a selected area within said bag, said lighting unit comprising:
a housing having a front wall, a back wall and a peripheral wall extending between said front wall and said back wall, said peripheral wall having a top side,
an attachment being coupled to said back wall, said attachment engaging said inner surface of said bag such that said housing is retained on said inner surface,
a stem being coupled to and extending upwardly from said top side, said stem having a distal end with respect to said top side, said stem being comprised of a flexible material thereby facilitating said distal end to be directed toward said selected area within said bag,
a light emitter being coupled to said distal end, said light emitter emitting light such that said light emitter selectively illuminates said selected area,
a switch being coupled to said front wall, said switch being electrically coupled to said light emitter such that said switch turns said light emitter on and off, and
a power supply being positioned within said housing, said power supply being electrically coupled to said switch, said power supply comprising at least one battery.
